(19) United States
(12) Patent Application Publication
(10) Pub. No.: US 2011/0149744 A1
(43) Pub. Date: Jun. 23, 2011

(54) METHOD AND APPARATUS FOR DIRECTING THE INSTALLATION OF VOIP DEVICES

(75) Inventors: Mabrouk Aboughanaima, Matawan, NJ (US); Daniel Smires, Freehold, NJ (US); Deepak Ottur, Hillsborough, NJ (US)

(73) Assignee: Vonage Network LLC, Holmdel, NJ (US)

(21) Appl. No.: 12/642,521

(22) Filed: Dec. 18, 2009

(51) Int. Cl. H04L 12/24

(52) U.S. Cl. 370/242

(57) ABSTRACT

A method and apparatus for directing the installation of a VoIP system. The method comprises performing one or more connectivity tests using a VoIP device to determine if the VoIP system is functional, receiving one or more inputs, determining a system status, and providing one or more instructional prompts. The inputs indicate the results of the one or more connectivity tests. The status is determined from the one or more results using the VoIP device. The instructional prompts are displayed in accordance with the determined status. The apparatus comprises means for performing one or more connectivity tests using a VoIP device, means for receiving input indicating one or more results for the one or more connectivity tests, means for determining a status for the VoIP system from the one or more results using the VoIP device, and means for providing instructional prompts for display depending upon the determined system status.

### BACKGROUND OF THE INVENTION

1. Field of the Invention

Embodiments of the present invention generally relate to Voice over Internet Protocol (VoIP) and, more particularly, to a method and apparatus for directing the installation of VoIP devices.

2. Description of the Related Art

Ubiquitous broadband internet access provides consumers with more options for communication than ever before. The high bandwidth provided by home networks provides an ideal platform for the transmission of telephony data. However, upgrading to these new communication platforms is often difficult due to the limitations of home wiring designed for legacy telephony systems.

Switching from a traditional Plain Old Telephone System (POTS) to a Voice over Internet Protocol (VoIP) system requires equipment that must be specially configured to interface with a particular home wiring setup. While the configuration is straightforward, occasionally customers run into difficulty with the setup process. Non-standard home wiring may require professional installation. Confusion with the setup instructions may result in a high volume of calls to technical support. It would be advantageous to provide a system to streamline the setup process and introduce customers to the basics of their VoIP system, thus reducing needless service calls. Therefore, there is a need in the art for a method and apparatus for installing VoIP devices.

### SUMMARY OF THE INVENTION

Embodiments of the present invention comprise a method and apparatus for directing the installation of a VoIP system. The method is performed by a VoIP device. The method comprises performing one or more connectivity tests using the VoIP device to determine if the VoIP system is functional, receiving one or more inputs at the VoIP device, determining a system status for the VoIP system, and providing one or more instructional prompts. The inputs indicate the results of the one or more connectivity tests. The system status is determined from the one or more results using the VoIP device. The instructional prompts are displayed in accordance with the determined status.

The apparatus comprises means for performing one or more connectivity tests using a VoIP device to determine if the VoIP system is functional, means for receiving input at the VoIP device indicating one or more results for the one or more connectivity tests, means for determining a system status for the VoIP system from the one or more results using the VoIP device, and means for providing instructional prompts for display depending upon the determined system status.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting a system in which an embodiment of the present invention is used;

FIG. 2 is a block diagram of a VoIP device using an embodiment of the present invention;

FIG. 3 is a block diagram of a VoIP device software architecture using an embodiment of the present invention;

FIG. 4 is a flow diagram depicting a method for directing the installation of a VoIP device in accordance with an embodiment of the present invention; and

FIGS. 5A and 5B are a flow diagram depicting a specific embodiment of a method for directing the installation of a VoIP device; and

FIG. 6 is a schematic diagram of a switch plug used in accordance with embodiments of the present invention.

### DETAILED DESCRIPTION

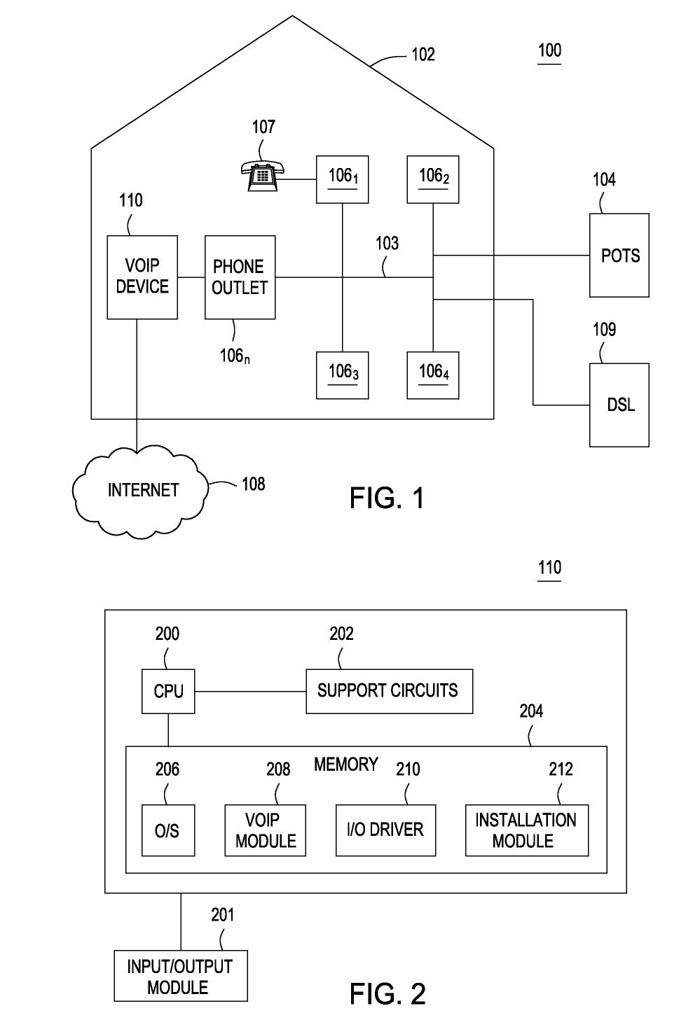

FIG. 1 depicts a home telephony system 100 containing an embodiment of the present invention. In a traditional home telephony system using a Plain Old Telephone System (POTS), telephone service is provided via an external POTS link 104. The POTS link 104 is coupled to a home wiring system 103. The home wiring system 103 is comprised of twisted pairs of copper wire for providing phone service to one or more phone outlets 106. One or more telephones 107 receive phone service by plugging in to the phone outlets 106. The home telephony system 100 may also receive internet access from a digital subscriber line (DSL) link 109. The DSL link 109 is also coupled to the home wiring system 103 and provides internet access.

Installing a VoIP system in a traditional home telephony system may prove difficult. A VoIP system requires a VoIP device 110 to replace the role of the POTS link 104. The term “VoIP system” refers to the combination of hardware and software elements required to receive VoIP telephony service, including the VoIP device 110, the home wiring 103, the phone outlets 106, and the telephones 107. The VoIP device 110 is coupled to a packet network 108 such as, but not limited to, the Internet. Telephone service is then provided over the home wiring system 103 by sending and receiving telephony data to a remote server (not shown) via the packet network 108.

In order to function properly, the VoIP device 110 must have full access to a telephone line on the home wiring system 103. If a POTS link 104 or DSL link 109 are still connected to the wiring pair to which the VoIP device 110 is connected, the VoIP device 110 will not function properly. If the home telephony system 100 does not have a free line that is not connected to a POTS link 104 or DSL link 109, then one of the links must be severed. Since most homes are set up for standard POTS service, installation of a VoIP system may prove problematic. As such, it is desirable for the VoIP device 110 to assist the user with troubleshooting, configuration, and initial setup.

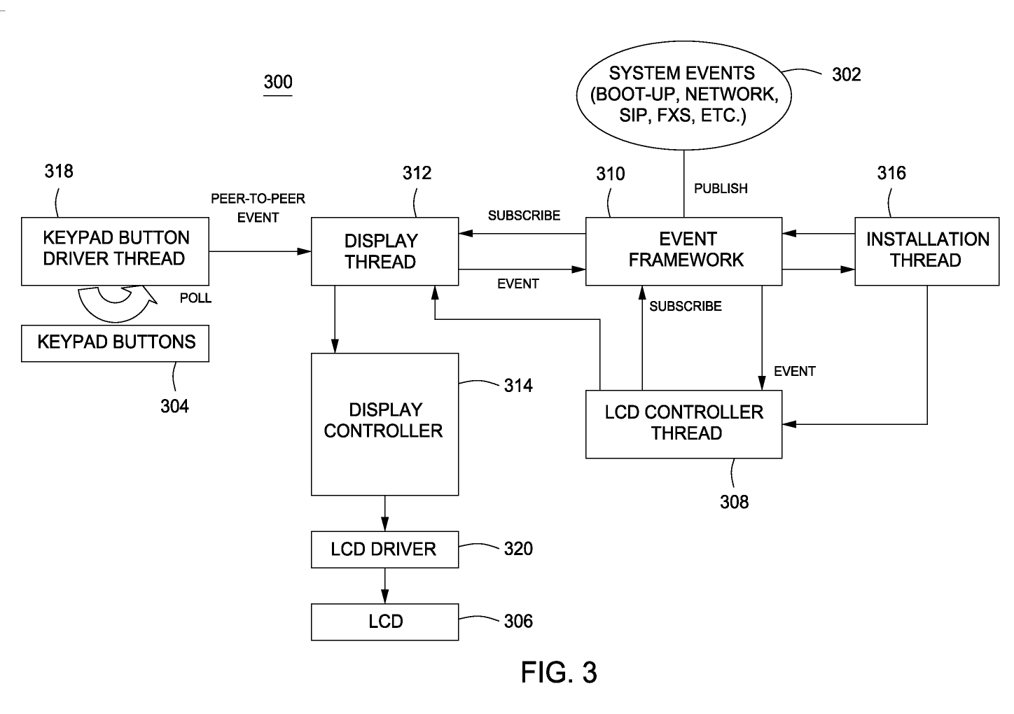

FIG. 2 depicts an embodiment of the VoIP device 110. In one embodiment, the VoIP device 110 is in the form of a general purpose computer such as those generally known in the art. The VoIP device 110 may include a central processing unit (CPU) 200, support circuits 202, and memory 204. The CPU 200 may comprise one or more commercially available microprocessors or microcontrollers that facilitate data processing and storage. The various support circuits 202 are utilized to facilitate the operation of the CPU 200 and include such circuits as clock circuits, power supplies, cache, input/output (I/O) circuits and devices, modulation/demodulation devices, subscriber line interface circuits, and the like. In some embodiments, the VoIP device 110 includes an I/O module 201. The I/O module 201 provides a method for displaying status and configuration data. In some embodiments, the I/O module 201 is a liquid crystal display (LCD) screen. In other embodiments, the I/O module 201 may provide a data interface, such as a serial port, an Ethernet port, a universal serial bus (USB) port, a web user interface, and the like. The I/O module 201 may further be comprised of one or more human interface devices, such as a keypad, mouse, touchpad, and the like, for inputting commands and/or responding to prompts displayed on the screen.

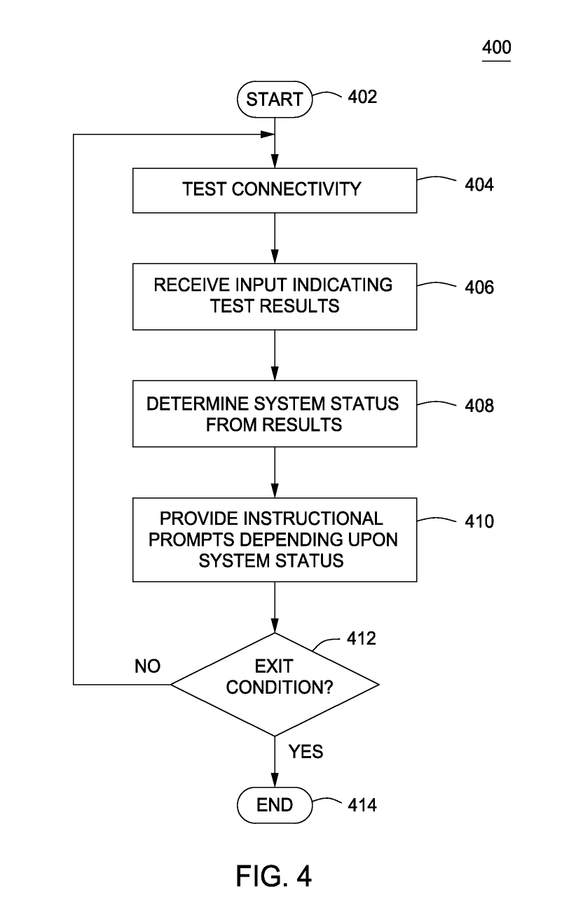

The memory 204 may comprise random access memory, read only memory, removable storage, optical disk storage, disk drive storage, flash memory, and combinations thereof. The memory 204 stores an operating system 206, a VoIP module 208, an I/O driver 210, and an installation module 212. The VoIP module 208 controls hardware responsible for providing home telephony services via the packet network 108. The software architecture of the VoIP device is discussed further with respect to FIG. 3. In operation, the CPU 200 executes the operating system 206 to control the general utilization and functionality of the host computer.

The memory 204 further comprises an I/O driver 210. The I/O driver 210 sends and receives data to and from the I/O module 201 to display data and, if the I/O module 201 includes one or more human interface devices, receive user input.

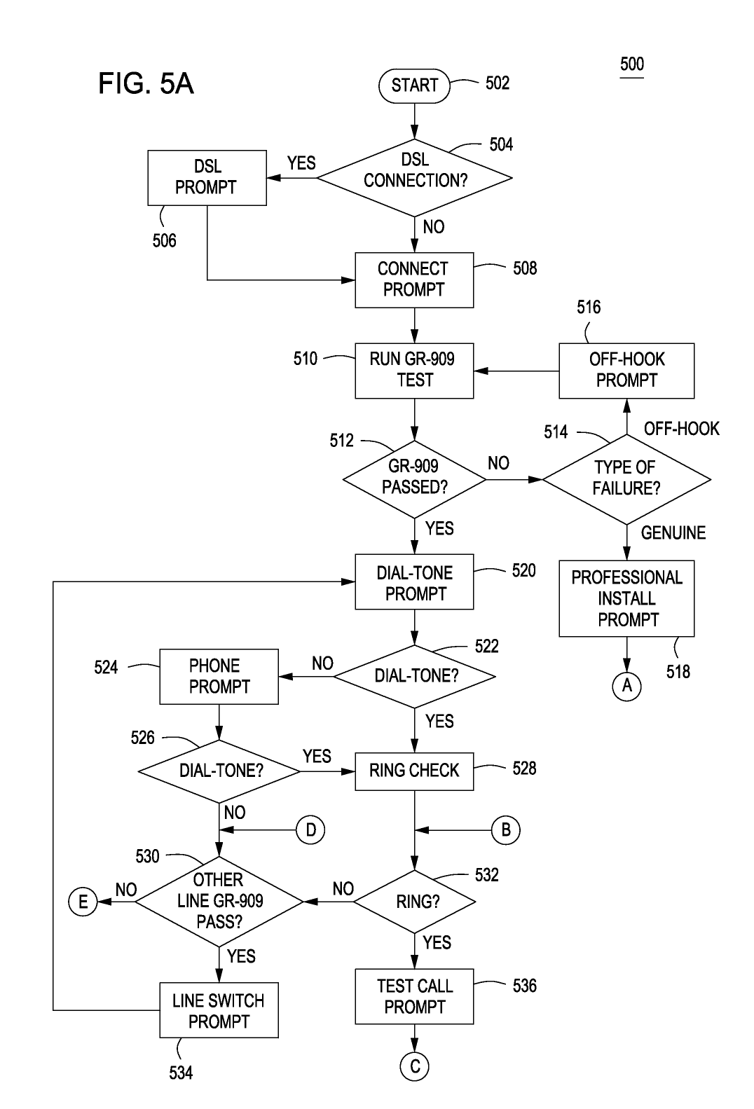

The memory 204 further comprises an installation module 212. The installation module 212 manages the installation and configuration process for connecting the VoIP device 110 to the home wiring 103. The installation module 212 sends information to the I/O module 201 via the I/O driver 210 for the purpose of displaying installation instructions. In response to various prompts received from the I/O module 201 via the I/O driver 210 (e.g. a keypad press by a user), the installation module 212 sends configuration and test commands to the VoIP module 208. The installation module 212 installs, tests, and configures the VoIP device 110 through this process of sending status updates and user commands to the I/O module 201 and receiving test and configuration data from the VoIP module 208. This process is discussed further with respect to FIG. 4.

FIG. 3 depicts a representational architecture 300 of software and related functions in accordance with an embodiment of the subject invention. Such architecture 300 includes gathering relevant system events 302 and printing appropriate messages via a LCD screen 306 via various event frameworks, threads, controllers and drivers as depicted. The architecture 300 also includes an Installation Thread 316 for executing connectivity tests, determining system status, providing user prompts for display by the LCD 306, and receiving input from the keypad buttons 304 via the event framework 310. Events 302 may include boot-up (including the above-presented downloading of the device profile), network, SIP call control, FXS events, or connectivity tests triggered by the Installation Thread 316. The architecture 300 also monitors keypad button events (generated by keypad buttons 304) and brings up a user menu on the LCD screen 306 in response to the keypad button events.

An LCD Controller thread 308 subscribes to specific events from an Event Framework 310 and maintains state information for Power-up states, Network states and Call states. It provides notification of state changes after appropriate filtering to a Display Thread 312. Based on the state, the Display Thread 312 calls the corresponding method in a Display Controller 314 to display appropriate messages. The Display Thread 312 accepts event notification from the LCD Controller thread 308, a Keypad Driver Thread 318 and some events from the Event Framework 310. It calls the corresponding method within to provide the event enumerations, which the Display Controller 314 uses to display appropriate messages on the LCD 306.

The Display Controller 314 runs in the context of the Display Thread 312. It accepts filtered events from the Display Thread 312. The Display Controller 314 also manages the icons. Prompts to the user from the Installation Thread 316 are sent to the display controller 314 via the LCD controller thread 308 and the display thread 312. The LCD controller thread 308 then sends the prompts to the LCD via a LCD driver 320. Since the ownership of the LCD 306 is always with the Display Controller 314, it prioritizes display of error messages over menu or informational messages. It may also block certain messages if it is displaying critical error messages.

FIG. 4 depicts a method 400 for directing the installation of a VoIP device in accordance with an embodiment of the present invention. The method begins at step 402, when the installation/configuration process has been initiated. At step 404, the VoIP device 110 tests whether the device is properly connected to the home phone system 100. In some embodiments, the connection between the VoIP device 110 and the phone outlet 106 is performed by a four pair wire connection (not shown). This four pair wire connection allows the VoIP device 110 to access all available wiring pairs to determine which, if any, are suitable for the VoIP system. In one embodiment, this testing and configuration process is performed by first asking the user if the home telephony system 100 is configured to provide Digital Subscriber Line (DSL) internet access. If the system 100 is set up for DSL access, the VoIP device 110 prompts the user to install a splitter between the VoIP device 110 and the phone outlet 106. The splitter splits the wiring connection from the phone outlet 106 so that the VoIP device 110 and DSL modem can both connect to the same phone outlet 106.

The VoIP device 110 then proceeds to test the device connectivity. The connectivity tests may include various tests to confirm that the VoIP device 110 is properly configured, including metallic loop tests, generating a phone test ring, creating a phone test call, and the like.

At step 406, the VoIP device 110 receives input indicating the results of the connectivity tests performed at step 404. In some embodiments, the input may be received internally in the device, such as determining the results of a metallic loop test. In other embodiments, the input may be provided in response to a user prompt. For example, the VoIP device 110 may generate a test ring on telephones hooked to the phone system 100. The VoIP device 110 will then prompt the user to indicate whether the phones rang to determine whether the test was successful.

At step 408, the VoIP device 110 determines the status of the phone system from the results acquired at step 406. Depending upon which tests were successful, the VoIP device 110 may determine a number of different statuses, such as which lines, if any, are properly registered, whether the device is capable of sending and receiving calls, the quality of voice communications, and the like.

At step 410, the VoIP device 110 provides instructional prompts to the user via the I/O module 201. In one embodiment, the I/O module 201 shows various text and graphics indicating the status determined at step 408. The instructional prompts provide the user with information required to properly configure the VoIP device 110. For example, if the user indicates that the home has a DSL connection, the instructional display will prompt the user to install a splitter module to access the proper line pair to avoid a conflict. The display may also be used to provide status indicators, such as which test is currently in progress, what input is expected from the user, whether the system configuration has been successfully completed, or whether professional installation will be required.

At step 412, the method 400 determines if an exit condition has been reached. Exit conditions include states where the system is properly configured, the system cannot be properly configured (e.g. faults exist in every available phone line), or the user has manually exited the installation module 212. If none of these conditions have occurred (e.g. the most recent test passed but the system is not completely configured), then the method returns to step 404 to run the next test. If one of the exit conditions has occurred, the method ends at step 414.

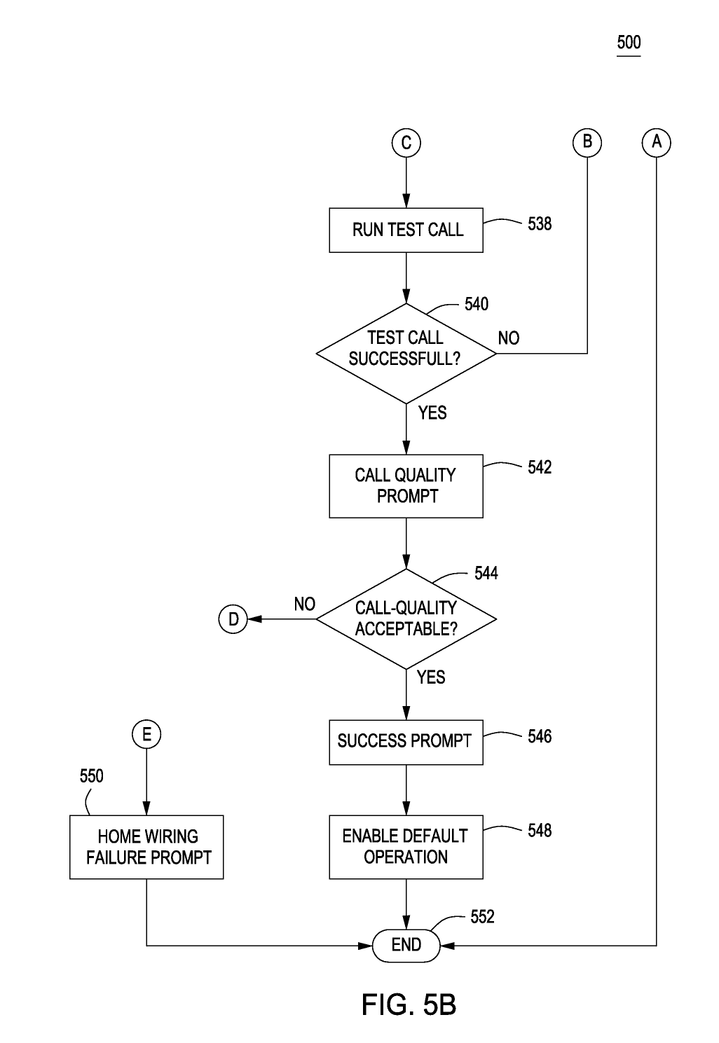

FIG. 5 depicts one embodiment of a method 500 for directing the installation of a VoIP device 110. The method begins at step 502 when the installation module 212 begins the installation process. At step 504, the VoIP device 110 prompts the user to select whether DSL service is installed on the home telephony wiring system 100. If DSL is installed, the method proceeds to step 506. At step 506, the VoIP device 110 prompts the user to connect the device and DSL cable through a splitter such that the DSL modem and VoIP device 110 are connected to separate wiring pairs. This prevents the installation of the VoIP device 110 from interfering with the DSL connection. If a DSL connection is not present, the method proceeds to step 508.

At step 508, the VoIP device 110 prompts the user to connect the VoIP device 110 to the phone outlet 106. The prompt instructs the user to press a key when the device is connected. The method then proceeds to step 510 once the connection process is complete.

At step 510, the VoIP device 110 runs a connectivity test to determine whether the home wiring 103 is sufficient to allow for VoIP service. In some embodiments, the VoIP device 110 may provide a prompt to the user to indicate this test is running, along with status information about the test results. In the event more than one phone line is registered for use with the VoIP service, then the connectivity test is performed on all present phone lines. In one embodiment, the connectivity test is a battery of one or more metallic loop tests to check for wiring faults. Such tests may include voltage tests, hazardous potential tests, foreign electromotive tests, resistive fault tests, receiver off-hook tests, ringer tests, and the like. In one specific embodiment, the series of connectivity tests performed is the TELCORDIA GR-909 test suite as known in the art, but one of ordinary skill in the art would recognize that there are a large variety of tests and diagnostics that can be used to determine line suitability and connectivity.

At step 512, the VoIP device 110 determines if the connectivity test was successful for at least one phone line. If the test was successful, the method proceeds to step 520. If the test failed, the method proceeds to step 514.

Step 514 is reached when the connectivity test fails for all phone lines. The VoIP device 110 then ascertains the type of failure. If the failure is a result of a phone being in an “off hook” state then the method proceeds to step 516. If the failure is due to another type of error, such as faulty wiring, the method proceeds to step 518.

At step 516, the VoIP device 110 prompts the user to hang up any phones that are off the hook. Once the user provides an acknowledgment that the error has been corrected, such as by pressing the appropriate key, the method proceeds back to the connectivity test at step 510.

At step 518, the VoIP device 110 has determined that a “genuine” fault has occurred and the system cannot be installed without a professional. The VoIP device 110 then displays a prompt indicating the user must contact a professional for installation. After displaying this prompt, the method proceeds to the end state at step 552.

At step 520, the method has successfully completed the connectivity test. The method then performs a prompt to instruct the user to check whether a dial-tone is present on a phone hooked into a phone outlet. The method then proceeds to 522 after displaying the prompt.

At step 522, the method receives input from the user indicating whether or not a dial-tone is present on a phone. If the user indicates there is no dial tone, then the method proceeds to 524. If the user indicates that there is a dial tone, then the method proceeds to step 528.

At step 524, the dial-tone test has failed. The VoIP device 110 then prompts the user to check the phone 107 and the connection of the phone 107 to the phone outlet 106. The prompt instructs the user to check the phone 107 for dial-tone after verifying the connection to the phone outlet 106. The method then proceeds to step 526.

At step 526, the user again checks the phone for dial-tone. If the user indicates dial-tone is present, the method proceeds to step 528. If the user indicates that dial-tone is not present, the method proceeds to step 530.

At step 528, the user has indicated that dial-tone is present on the phone 107. The VoIP device 110 then performs a ring check. The ring check is performed by simulating an incoming call on the phone system, such that the phone 107 should ring. The method then proceeds to step 532 after simulating the ring.

At step 532, the VoIP device 110 prompts the user to indicate whether or not the phone 107 rang. If the user indicates the phone 107 did not ring, the method proceeds to step 530. If the user indicates that the phone 107 rang, the method proceeds to step 536.

At step 530, the VoIP device 110 determines whether an alternate line previously passed the connectivity test at step 510, because the first line appears to have an error. If an alternate line passed the connectivity test, the method proceeds to 534. If no alternate line passed the connectivity test, the method proceeds to step 550.

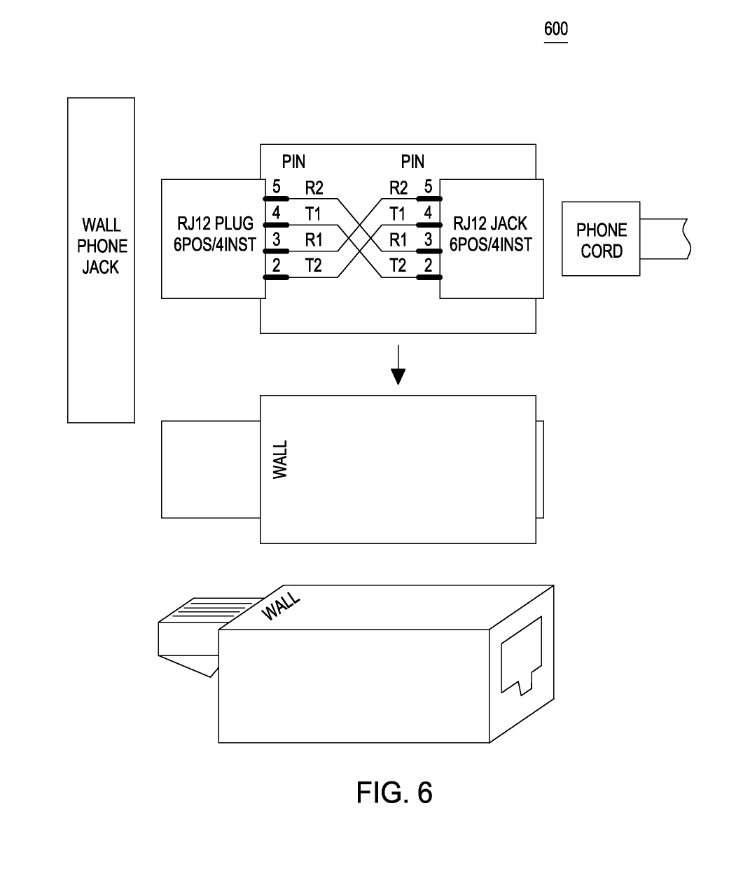

At step 534, an alternate line has passed the connectivity test after initial connectivity testing has failed. The VoIP device 110 then prompts the user to install a switch plug between each telephone 107 and each phone outlet 106 to switch the phone outlet connection to the appropriate line. The operation of the switch plug is discussed in further detail with respect to FIG. 6. The VoIP device 110 waits for the user to indicate that this step has been completed. After the user indicates that the plug(s) have been installed, the method proceeds to step 520 to repeat the dial-tone test for the alternate line.

At step 536, the user has indicated that the ring testing of step 528 was successful. The VoIP device 110 prompts the user to indicate it will generate a test call, and the user should pick up the phone 107 and speak into it when it rings. The VoIP device 110 then generates an outgoing test call. In one embodiment, the VoIP device 110 creates an outgoing test call by contacting a remote device at a particular phone number.

At step 538, the device 110 first indicates the user should pick up the phone 107 as it begins to ring. When the device 110 registers that the phone 107 is in an “off hook” state, the device 110 generates a call to a given phone number. The given phone number connects to an echo server, and the user is prompted to speak into the phone 107 to generate a voice communication. The voice communication is then played back to the user to determine the quality of the connection. The method then proceeds to step 540.

At step 540, the VoIP device 110 determines whether or not the test call was successful. If the test call was successful, then the method proceeds to step 542. According to some embodiments, the success of the test call is determined internal to the device (e.g. the device registers that the echo server answered the call). According to some embodiments, the success of the test call is determined by a user prompt (e.g. the user presses the keypad to acknowledge the success of the call). If the test call was not successful, then the method proceeds to step 532 to test whether the phone 107 rings properly.

At step 542, the VoIP device 110 prompts the user to indicate whether the voice quality of the test call was acceptable. If the user indicates that the quality was acceptable, the method proceeds to step 546. If the user indicates the quality was not acceptable, then the method proceeds to step 530 to determine if other lines are available.

At step 546, the tests have completed successfully and the VoIP device 110 displays a prompt indicating that the device has been successfully configured. The method then proceeds to step 548.

At step 548, the VoIP device 110 enters default operation. In one embodiment, the LCD screen is modified to show the date and time, rather than setup information. At this point, the VoIP device 110 is properly configured to send and receive calls. The method ends at step 552 after the installation module 212 has either determined the tests were successful or unsuccessful.

FIG. 6 is a schematic diagram of a switch plug 600 used in accordance with embodiments of the present invention. The switch plug 600 swaps the inner and outer pairs of wiring when the connectivity tests indicate that the VoIP device can be connected to one of the lines of the home wiring system 103, but not necessarily the primary line, where the primary line is defined as the default line when a phone is connected to the phone outlet 106. The wiring swap configuration maintains the polarity of the tip (T1 and T2) and ring (R1 and R2) line voltages which ensures proper operation of the VoIP device 110 (TA). By switching the pins present within the phone jack 106, the switch plug 600 allows the telephone 107 to connect to an alternate pair of wiring when the primary pair is unsuitable for VoIP service (e.g. the primary pair is servicing a DSL connection or otherwise connected to a POTS system 104).

While the foregoing is directed to embodiments of the present invention, other and further embodiments of the invention may be devised without departing from the basic scope thereof, and the scope thereof is determined by the claims that follow.

1. A method for directing the installation of a voice-over internet protocol (VoIP) system, at least a portion of the method being performed by a VoIP device, the method comprising:
performing one or more connectivity tests using the VoIP device to determine if the VoIP system is functional;
receiving one or more inputs at the VoIP device indicating one or more results for the one or more connectivity tests;
determining a system status for the VoIP system from the one or more results using the VoIP device; and
providing one or more instructional prompts for display depending upon the determined system status.

2. The method of claim 1, wherein the connectivity tests comprise at least one of a metallic loop test, a dial-tone test, a ring test, a test call, or a call quality test.

3. The method of claim 1, wherein the instructional prompts are provided via an input/output module.

4. The method of claim 3, wherein the input/output module comprises at least one of a liquid crystal display, an Ethernet port, a serial port, a web interface and a universal serial bus port.

5. The method of claim 3, wherein the input/output module comprises one or more human interface devices for providing the inputs indicating the one or more results.

6. The method of claim 1, wherein the performing step further comprises:
running one or more metallic loop tests;
running a dial-tone test;
running a ring test;
generating a test call; and
running a call-quality test.

7. The method of claim 6, further comprising providing a success prompt after all tests have successfully completed.

8. An apparatus for directing the installation of a voice-over internet protocol (VoIP) system, comprising:
means for performing one or more connectivity tests using a VoIP device to determine if the VoIP system is functional;
means for receiving input indicating one or more results at the VoIP device for the one or more connectivity tests;
means for determining a system status for the VoIP system from the one or more results using the VoIP device; and
means for providing instructional prompts for display depending upon the determined system status.

9. The apparatus of claim 8, wherein the connectivity tests comprise at least one of a metallic loop test, a dial-tone test, a ring test, a test call, or a call quality test.

10. The apparatus of claim 8, wherein the instructional prompts are provided via an input/output module.

11. The apparatus of claim 10, wherein the input/output module comprises at least one of a liquid crystal display, an Ethernet port, a serial port, a web interface, and a universal serial bus port.

12. The apparatus of claim 10, wherein the input/output module comprises one or more human interface devices for providing the inputs indicating the one or more results.

13. The apparatus of claim 10, wherein the input/output module comprises a liquid crystal display for displaying the instructional prompts and a keypad for providing the one or more test results.

14. A computer readable medium having stored thereon instructions that when executed by a processor cause the processor to perform a method for directing the installation of a voice-over internet protocol (VoIP) system, the method comprising:
performing one or more connectivity tests using a VoIP device to determine if a VoIP system is functional;
receiving input indicating one or more results at the VoIP device for the one or more connectivity tests;
determining a system status for the VoIP system from the one or more results using the VoIP device; and
providing instructional prompts for display depending upon the determined system status.

15. The computer readable medium of claim 14, wherein the connectivity tests comprise at least one of a metallic loop test, a dial-tone test, a ring test, a test call, and a call quality test.

16. The computer readable medium of claim 14, wherein the instructional prompts are provided via an input/output module.

17. The computer readable medium of claim 16, wherein the input/output module comprises at least one of a liquid crystal display, an Ethernet port, a serial port, a web interface and a universal serial bus port.

18. The computer readable medium of claim 16, wherein the input/output module comprises one or more human interface devices for providing the inputs indicating the one or more results.

19. The computer readable medium of claim 14, wherein the performing step further comprises:
running a metallic loop test;
running a dial-tone test;
running a ring test;
generating a test call; and
running a call-quality test.

20. The computer readable medium of claim 14, further comprising providing a success prompt after all tests have successfully completed.
